(19) United States
(12) Patent Application Publication
(10) Pub. No.: US 2011/0025513 A1
(43) Pub. Date: Feb. 3, 2011

(54) METHOD FOR CARRYING OUT SINGLE TOUCH OPERATION BY MEANS OF COMPUTER INPUT DEVICES

(75) Inventor: YUNG-LUNG LIU, Ta Ya Shiang (TW)

Correspondence Address: G. LINK CO., LTD., 3550 BELL ROAD, MINOOKA, IL, 60447, US

(73) Assignee: Sunrex Technology Corp., Ta Ya Shiang (TW)

(21) Appl. No.: 12/512,501

(22) Filed: Jul. 30, 2009

(51) Int. Cl. G08B 21/00; G09G 5/00

(52) U.S. Cl. 340/635; 345/156

(57) ABSTRACT

A method for carrying out a single touch operation by means of a plurality of function keys and a mouse of a computer in one embodiment is provided. The method includes the steps of (a) enabling a sensor to detects an input signal; (b) determining whether one of the function keys is pressed by processing the input signal; (c) if the determination in step (b) is yes, the method continuing to step (d) else the method looping back to step (b); (d) detecting a movement of the mouse; (e) determining which one of the function keys is pressed; and (f) performing an operation corresponding to the pressed function key by cooperating with the movement of the mouse if the detection of the movement of the mouse is positive.

### BACKGROUND OF THE INVENTION

1. Field of Invention

The invention relates to input devices and more particularly to a method for carrying out a single touch operation by means of computer input devices.

2. Description of Related Art

For example, a resistive touchscreen panel of the prior art is comprised of, among other layers, two indium tin oxide (ITO) layers separated by a narrow gap. When an object (e.g., finger) presses down on a point on the panel's outer surface the ITO layers become connected at that point. Then panel behaves as a pair of voltage dividers with connected outputs. This causes a change in the electrical current which is registered as a touch event and sent t a controller for processing. One drawback of the resistive touchscreen panel is that short circuit may occur if the resistance is not sufficiently large.

Moreover, a grid type touchscreen panel comprises two grids on both sides of a display for emitting infrared (IR) light rays. A relative position of the finger on the touchscreen panel can be determined by a controller by processing the intersection point of the IR light rays.

However, the well known grid type touchscreen panel suffers from several disadvantages. For example, a large area of the panel for IR illumination is required, resulting in a great increase of the manufacturing cost. Further, image fetch can be adversely affected when both hands are on the panel. And in turn, a correct determination of the relative position of the finger on the panel cannot be obtained. Furthermore, features such as “multi-touch on screen” and WM_GESTURE provided by Windows 7 are not applicable to a computer display without a screen capable of effecting a multi-touch.

A user may use two or more fingers to carry out screen enlargement, rotation, or the like on a conventional touchpad with “multi-touch on screen”. However, above features are not available for a type of “single touch” touchpad or computer mouse.

It is thus desirable to employ the conventional mouses or touchpads to perform computer screen operations by means of “single touch”. This is because it has the advantages of low cost, easy operation, convenience, and without being interfered with the existing learning methods of gesture input and other conventional gestures. Thus, it is desirable to provide a novel method for carrying out a single touch operation by means of computer input devices in order to overcome the inadequacies of the prior art.

### SUMMARY OF THE INVENTION

It is therefore one object of the invention to provide a method for carrying out a single touch operation by means of computer input devices

In one aspect of the invention there is provided a method for carrying out a single touch operation by means of a plurality of function keys and a mouse of a computer, the method comprising the steps of (a) enabling a sensor to detects an input signal; (b) determining whether one of the function keys is pressed by processing the input signal; (c) if the determination in step (b) is yes, the method continuing to step (d) else the method looping back to step (b); (d) detecting a movement of the mouse; (e) determining which one of the function keys is pressed; and (f) performing an operation corresponding to the pressed function key by cooperating with the movement of the mouse if the detection of the movement of the mouse is positive.

In another aspect of the invention there is provided a method for carrying out a single touch operation by means of a plurality of function keys and a touchpad of a computer, the method comprising the steps of (a) enabling a sensor to detects an input signal; (b) determining whether one of the function keys is pressed by processing the input signal; (c) if the determination in step (b) is yes, the method continuing to step (d) else the method looping back to step (b); (d) detecting a finger movement on the touchpad; (e) determining which one of the function keys is pressed; and (f performing an operation corresponding to the pressed function key by cooperating with the finger movement on the touchpad if the detection of the finger movement on the touchpad is positive.

The above and other objects, features and advantages of the invention will become apparent from the following detailed description taken with the accompanying drawings.

### BRIEF DESCRIPTION OF THE DRAWINGS

FIG. 1 is a flowchart depicting a process according to the invention;

FIG. 2 is a flowchart depicting a process of selecting one of a plurality of function keys according to the invention;

FIG. 3 is a top plan view of a computer keyboard incorporating the function keys according to a first preferred embodiment of the invention;

FIG. 4 is a top plan view of a touchpad incorporating the function keys according to a second preferred embodiment of the invention;

FIG. 5 is a perspective view of a computer keyboard incorporating the touchpad of FIG. 4; and

FIG. 6 is a perspective view of the computer keyboard shown in FIG. 3 being cooperated with a mouse in operation.

### DETAILED DESCRIPTION OF THE INVENTION

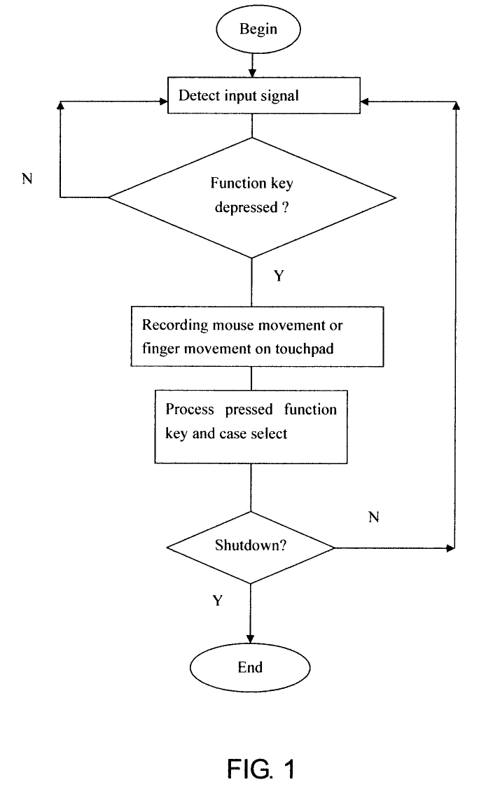

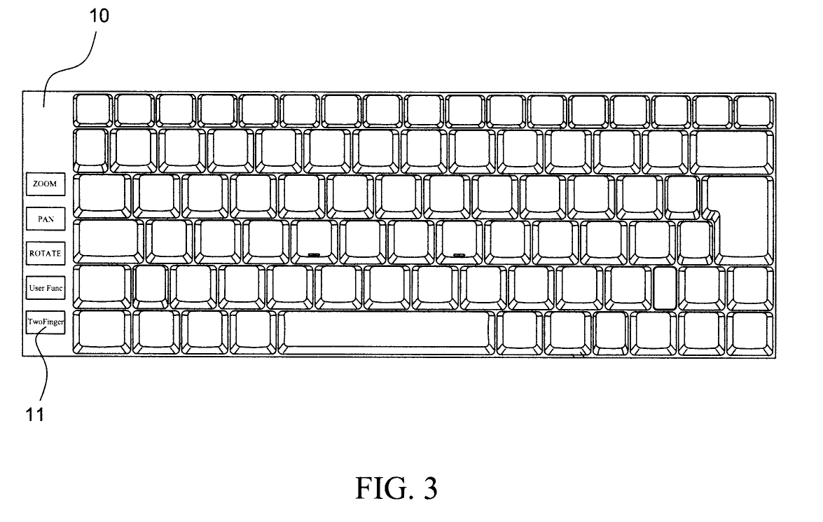

Referring to FIGS. 1 to 6, a method for carrying out a single touch operation by means of computer input devices in accordance with the invention comprises the following components as discussed in detail below.

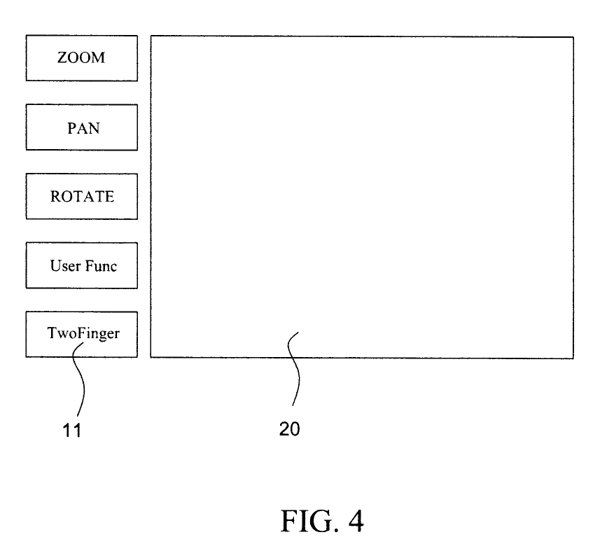

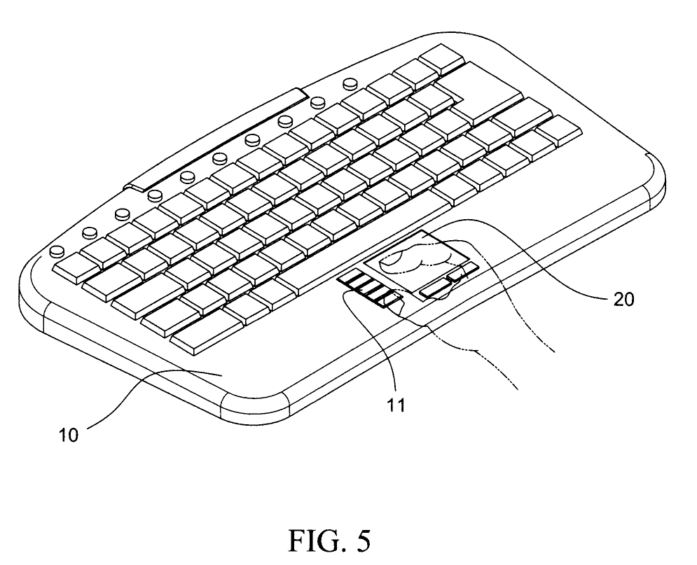

A keyboard 10 is implemented as a desktop computer keyboard or a notebook computer keyboard. A plurality of function keys 11 are provided on, for example, left side of the keyboard 10 (see FIG. 1) or left side of a touchpad 20 located on a lower portion of the keyboard 10 (see FIGS. 4 and 5). The function keys 11 are comprised of ZOOM key, PAN key, ROTATE key, MAG key, USER FUNCTIONS key, TWO FINGERS key, and MORE FINGERS key in which ZOOM key, PAN key, ROTATE key, and MAG key are conventional function keys; and USER FUNCTIONS key, TWO FINGERS key, and MORE FINGERS key are special function keys of the invention. But their operations are of the same.

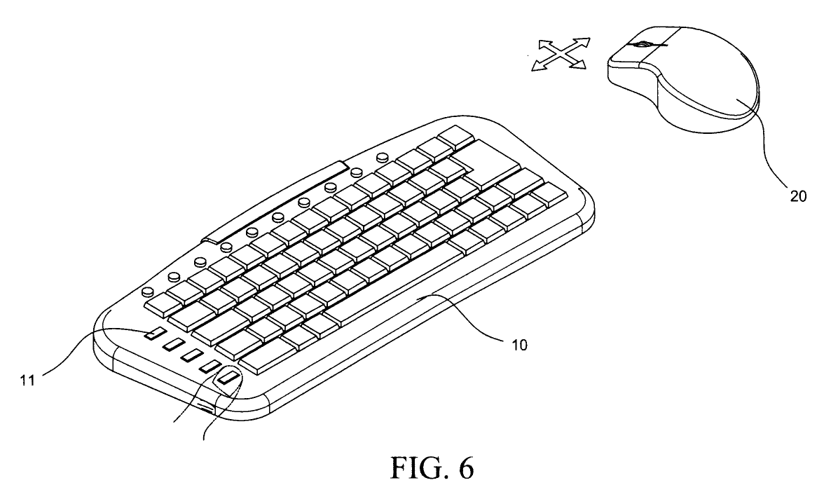

An input device 20 is a computer mouse 20 (see FIG. 6) or a touchpad 20 (see FIGS. 4 and 5). A rotational movement of the mouse 20 or a sliding finger movement on the touchpad 20 can effect a cursor movement on the screen as detailed below.

As illustrated in the process of FIG. 1, first a sensor detects an input signal. Next, it is determined whether a function key 11 is pressed by processing the input signal. If yes, the process continues. Otherwise, the process loops back to the first step. A movement of the mouse 20 or a movement of the finger on the touchpad 20 is then detected. Next, it is determined which function key 11 is pressed and a corresponding operation is then performed. In short, a user may press a desired function key 11 and an operation corresponding to the function key 11 is then performed by cooperating with the movement of the mouse 20 or the movement of the finger on the touchpad 20 if the detection of the mouse movement or the finger movement is positive. That is, it is a single touch operation.

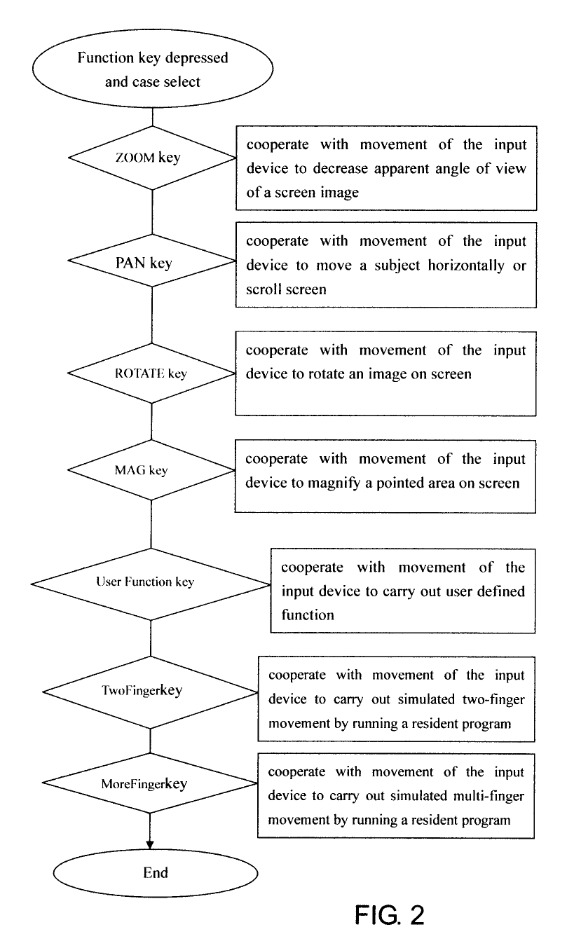

As illustrated in the process of FIG. 2, operations corresponding to different function keys 11 are illustrated.

In the case of the input device 20 being a mouse 20, a pressing of the ZOOM key in cooperation with a movement (e.g., up, down, left, or right) of the mouse 20 will decrease the apparent angle of view of an image on a centered area on the screen; a pressing of the PAN key in cooperation with a movement (e.g., left or right) of the mouse 20 will move a subject on the screen horizontally; a pressing of the PAN key in cooperation with a movement (e.g., up or down) of the mouse 20 will scroll the screen; a pressing of the ROTATE key in cooperation with a movement (e.g., left or right) of the mouse 20 will rotate an image on the screen clockwise; a pressing of the ROTATE key in cooperation with a movement (e.g., up or down) of the mouse 20 will rotate the image on the screen counterclockwise; a pressing of the MAG key in cooperation with a movement (e.g., up, down, left, or right) of the mouse 20 will magnify a pointed area on the screen; a pressing of the USER FUNCTIONS key in cooperation with a rightward movement of the mouse 20 will carry out a first user defined function; a pressing of the USER FUNCTIONS key in cooperation with a upward movement of the mouse 20 will carry out a second user defined function; a pressing of the USER FUNCTIONS key in cooperation with a leftward movement of the mouse 20 will carry out a third user defined function; a pressing of the USER FUNCTIONS key in cooperation with a downward movement of the mouse 20 will carry out a fourth user defined function; a pressing of the TWO FINGERS key in cooperation with a movement (e.g., up, down, left, or right) of the mouse 20 will carry out a simulated two-finger movement by running a resident program in which a distance between two fingers can be measured based on a horizontal movement of the cursor on the screen, and an angle between two fingers can be measured or DELTA parameter can be determined based on a horizontal movement of the cursor on the screen; and a pressing of the MORE FINGERS key in cooperation with a movement (e.g., up, down, left, or right) of the mouse 20 will carry out a simulated multi-finger movement by running a resident program.

In the case of the input device 20 being a touchpad 20, a pressing of the ZOOM key in cooperation with a finger movement (e.g., up, down, left, or right) on the touchpad 20 will decrease the apparent angle of view of an image on a centered area on the screen; a pressing of the PAN key in cooperation with a finger movement (e.g., left or right) on the touchpad 20 will move a subject on the screen horizontally; a pressing of the PAN key in cooperation with a finger movement (e.g., up or down) on the touchpad 20 will scroll the screen; a pressing of the ROTATE key in cooperation with a finger movement (e.g., left or right) on the touchpad 20 will rotate an image on the screen clockwise; a pressing of the ROTATE key in cooperation with a finger movement (e.g., up or down) on the touchpad 20 will rotate the image on the screen counterclockwise; a pressing of the MAG key in cooperation with a finger movement (e.g., up, down, left, or right) on the touchpad 20 will magnify a pointed area on the screen; a pressing of the USER FUNCTIONS key in cooperation with a rightward movement on the touchpad 20 will carry out a first user defined function; a pressing of the USER FUNCTIONS key in cooperation with an upward movement on the touchpad 20 will carry out a second user defined function; a pressing of the USER FUNCTIONS key in cooperation with a leftward movement on the touchpad 20 will carry out a third user defined function; a pressing of the USER FUNCTIONS key in cooperation with a downward movement on the touchpad 20 will carry out a fourth user defined function; a pressing of the TWO FINGERS key in cooperation with a finger movement (e.g., up, down, left, or right) on the touchpad 20 will carry out a simulated two-finger movement by running a resident program in which a distance between two fingers can be measured based on a horizontal movement of the cursor on the screen, and an angle between two fingers can be measured or DELTA parameter can be determined based on a horizontal movement of the cursor on the screen; and a pressing of the MORE FINGERS key in cooperation with a finger movement (e.g., up, down, left, or right) on the touchpad 20 will carry out a simulated multi-finger movement by running a resident program.

The invention has the following advantages. Low cost, easy operation, convenience, and without being interfered with the existing learning methods of gesture input and other conventional gestures.

While the invention herein disclosed has been described by means of specific embodiments, numerous modifications and variations could be made thereto by those skilled in the art without departing from the scope and spirit of the invention set forth in the claims.

What is claimed is:

1. A method for carrying out a single touch operation by means of a plurality of function keys and a mouse of a computer, the method comprising the steps of:
(a) enabling a sensor to detects an input signal;
(b) determining whether one of the function keys is pressed by processing the input signal;
(c) if the determination in step (b) is yes, the method continuing to step (d) else the method looping back to step (b);
(d) detecting a movement of the mouse;
(e) determining which one of the function keys is pressed; and
(f) performing an operation corresponding to the pressed function key by cooperating with the movement of the mouse if the detection of the movement of the mouse is positive.

2. The method of claim 1, wherein the function keys are disposed on a keyboard of the computer; and wherein the function keys are comprised of a ZOOM key, a PAN key, a ROTATE key, a MAG key, a USER FUNCTIONS key, a TWO FINGERS key, and a MORE FINGERS key.

3. A method for carrying out a single touch operation by means of a plurality of function keys and a touchpad of a computer, the method comprising the steps of:
20 (a) enabling a sensor to detects an input signal;
(b) determining whether one of the function keys is pressed by processing the input signal;
(c) if the determination in step (b) is yes, the method continuing to step (d) else the method looping back to step (b);
(d) detecting a finger movement on the touchpad;
(e) determining which one of the function keys is pressed; and
(f) performing an operation corresponding to the pressed function key by cooperating with the finger movement on the touchpad if the detection of the finger movement on the touchpad is positive.

4. The method of claim 3, wherein the function keys are disposed on a keyboard of the computer; and wherein the function keys are comprised of a ZOOM key, a PAN key, a ROTATE key, a MAG key, a USER FUNCTIONS key, a TWO FINGERS key, and a MORE FINGERS key.
